(19) United States
(12) Patent Application Publication
(10) Pub. No.: US 2008/0311978 A1
(43) Pub. Date: Dec. 18, 2008

(54) CASHLESS METHOD OPERATING A NETWORK OF GAMING MACHINES

(75) Inventor: Michel Vienneau, Dieppe (CA)

Correspondence Address: SEAN LIAM KELLEHER;Kelleher IP PLLC, 16 PECKSLIP RD, CARMEL, NY, 10512, US

(73) Assignee: NANOPTIX INC., Dieppe (CA)

(21) Appl. No.: 12/114,736

(22) Filed: May 2, 2008

Related U.S. Application Data
(60) Provisional application No. 60/915,439, filed on May 2, 2007.

(51) Int. Cl. A63F 9/24; A63F 13/12

(52) U.S. Cl. 463/25; 463/42

(57) ABSTRACT

A cashless method for operating a network of gaming machines from a central host station is provided. The host station issues a unique token with a unique player validation number. The attendant of the host station enters the amount given by the player into host station. The player activates a gaming machine from a system of gaming machines through the use of the gaming token. Upon activating gaming machine, credits from host machine are transferred to gaming machine. Once play has terminated on the gaming machine, the player may cashout any remaining credits or may simply activate another gaming machine through the use of the token.

### FIELD OF THE INVENTION

The present invention relates to a cashless method for operating a network of gaming or amusement machines from a host station.

### BACKGROUND OF THE INVENTION

Gaming machines, particularly slot machines, have in recent years become one of the more popular, exciting, and sophisticated wagering activities available at casinos and other gambling locations. At the same time, slot machines have also become a source of greater revenue for gaming establishments.

Typically, a player, when finished playing, “cashes out” at the slot machine by activating a cashout button. At that time, the slot machine converts the amount of credits pending in the slot machine to a currency payout that is dispensed (e.g., as coins) to the player. The player must then collect all of the coins, fill a cup or pockets, then move to the next slot machine and reenter all of the coins. Thus, the prior payout techniques tended to interrupt gameplay, thereby reducing profits and also reducing the excitement and entertainment experience that arise from uninterrupted game play.

In the past, slot machines have attempted to address the interruption caused when a player collects coins and moves to another slot machine. In particular, some slot machines have issued paper tickets that encode the amount of credit pending in the slot machine when the player presses the cashout button. The player may then simply pick up the ticket dispensed by the slot machine and proceed to a new slot machine without incurring the time delay and distraction associated with collecting currency and reinserting it into the new slot machine.

Successful ticketing, however, requires a comprehensive system level approach to ensure that the tickets are secure (e.g., they cannot be duplicated and reused, they cannot be forged, and the like), that as many slot machines as possible can accept tickets, and that ticketing does not cause as much interruption as the coin/currency payout that the tickets are designed to replace. However, in prior ticketing systems for example, the slot machines typically had to spend the time and processing resources to generate their own ticket validation numbers, or had to incur the delay of requesting a ticket validation number from a central authority each time the slot machine needed to print a ticket. As a result, prior slot machines exposed the player to unnecessary processing delay, thereby slowing play, and reducing the overall level of player enjoyment.

In another approach, cards such as credit cards are used. In the case of credit cards, there exists a strong public policy not to allow a person gambling to have access to the credit limit of their credit card at the various gaming machines. Hence, credit card ATM terminals are provided at various other locations in a casino to allow a person to access the credit available in their credit card and then to have it provide cash to the player. The player can then take the cash to the gaming machine or to the cashier to receive tokens. This step of forcing the gambler to go to a remote location and receive cash causes the gambler to think before using credit available on a credit card in the emotional heat of a game.

In another approach, a player card is used to encode the magnetic stripe on the card with the amount of the cash-out from one gaming machine so that the player can use the imprinted amount to play at another gaming machine.

In yet another approach, a player card is used and all communications with respect to the gambler's current balance is displayed at a particular machine. For example, upon insertion of a player card at a first machine, if the player has a balance of $500.00, the player can go to a second machine and insert the card and a central computer will display $500.00 available for playing at the second machine.

It is known to remotely credit and bill usage of electronic entertainment machines, see for example U.S. Pat. Nos. 5,197,094 and 5,429,361. These conventional systems, however, require expensive technology such as modems or card readers, keypads, and the like. In small establishments having a limited number of gaming machines, it would be desirable to have a game-credit control and accounting apparatus that monitors multiple gaming machines using relative inexpensive technology. Cost savings to the establishment can be achieved through the relatively low cost of the control and accounting device as well as the reduced labor expense since employees may remain in a central work area and carry on with other duties while redeeming game credits.

A need has long existed in the industry for a cashless method to operate a gaming system that addresses the problems noted above and other previously experienced.

### SUMMARY OF THE INVENTION

According to one embodiment of the present invention a cashless method to operate a network of gaming machines from a central station is provided. The host station issues a unique token with a unique player validation number. The attendant of the host station enters the amount given by the player into host station. The player activates a gaming machine from a system of gaming machines through the use of the gaming token. Upon activating gaming machine, credits from host machine are transferred to gaming machine. Once play has terminated on the gaming machine, the player may cashout any remaining credits or may simply activate another gaming machine through the use of the token.

### BRIEF DESCRIPTION OF THE DRAWINGS

The detailed description particularly refers to the accompanying figures in which:

FIG. 1 is a flow chart of a cashless method according to one embodiment of the present invention for operating a network of two gaming machines;

FIG. 2 is a flow chart of a cashless method according to one embodiment of the present invention for operating a network of six gaming machines;

FIG. 3 is a flow chart of a cashless method according to one embodiment of the present invention for operating a network of N gaming machines;

FIG. 4 is a flow chart of a cashless method according to another embodiment of the present invention for operating a network of N gaming machines;

FIG. 5 is a flow chart of a method according to one embodiment of the present invention for operating a network of six gaming machines;

FIG. 6 is a flow chart of a cashless method according to one embodiment of the present invention for operating a network of eighteen gaming machines.

### DETAILED DESCRIPTION OF THE DRAWINGS

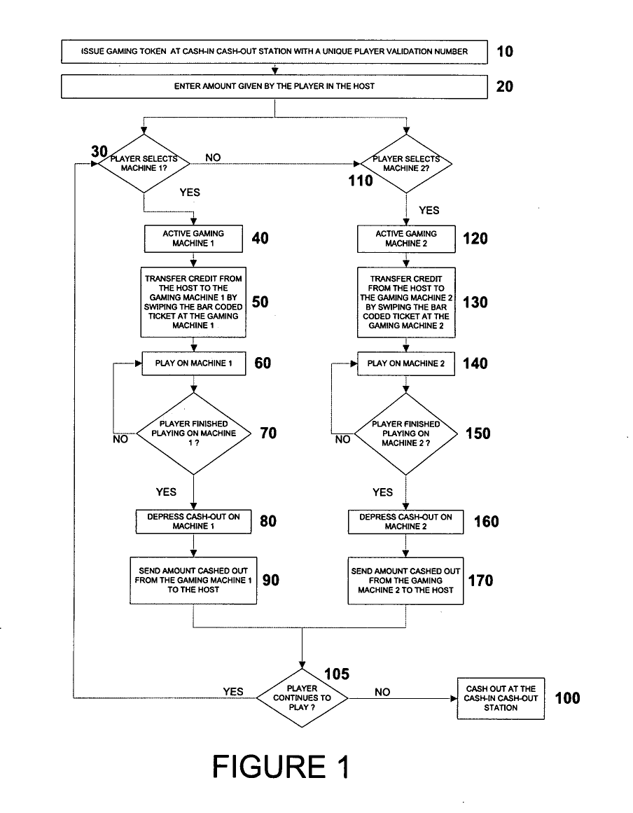

With reference to FIG. 1, the cashless method according to one embodiment of the present invention is shown for two gaming machines, however the cashless method of the present invention can integrate N gaming machines and still be within the cashless method of the present invention.

With further reference to FIG. 1, step 10 comprises the issuance of a unique gaming token. A gaming token under the present invention can comprise any element which can be used in gaming rooms and representing a predetermined or non-predetermined nominal value, whether this is an actual token in the form of a disk or a gaming chip. In general, the tokens are manufactured from rigid and scratch resistant plastic. The tokens exhibit varied patterns in terms of design and in terms of colors in order to reduce the risks of falsification and/or fraudulent reproductions. In one embodiment of the present invention the gaming token is a bar coded ticket. For example, a heavy duty kiosk printer can print out an inexpensive cardstock receipt with a barcode.

A worker skilled in the relevant art would understand that a variety of applications could be utilized as a gaming token to activate a gaming machine under the present cashless method. As a further example, an RFID badge, a magnetic strip card or a smart card could be used as a gaming token. A worker skilled in the relevant art would also be familiar with the fact that the use of a magnetic strip card could also encompass a magnetic strip card with a rewriteable thermal side to print the remaining credits left to play on a gaming machine as further discussed below.

Other examples to activate the gaming machine according to the method of the present invention are the providing of a manually given validation number to be entered into the gaming machine instead of a bar coded ticket. Yet a further example is an electronically stored validation number that can be downloaded to the gaming machine via a wireless modem or through electrical connection. Another example that a worker skilled in the relevant art would be familiar with regarding the activation of a gaming machine would be the use of electronic fingerprints through the use of sensors located on the gaming machine itself.

With further reference to FIG. 1, the gaming token of the present invention is issued when a player provides currency in order to play a gaming machine. Once the currency is received by an attendant, the currency is entered into the host station under step 20. In another embodiment, the currency entered into the host station can be done through the use of a self-service kiosk and completed by the player.

With further reference to FIG. 1, the player then selects a gaming machine to activate at step 30. A gaming machine may be activated through the use of the gaming token in the form of a bar coded ticket by simply placing the bar coded gaming token in a bar code reader of gaming machine 1 under step 40. Once gaming machine 1 is activated, the credits entered into the host station are transferred to gaming machine for play on gaming machine 1 under step 50. Once the credits are transferred to the gaming machine 1, the player may play gaming machine 1 until all credits are used or until the player decides to stop playing gaming machine 1 under steps 60 and 70. If the player decides to stop playing gaming machine 1 and still has credits remaining in gaming machine 1, the player simply depresses a cashout option present on gaming machine 1 under step 80.

Once the depress cashout function is activated on gaming machine 1, the credits remaining on gaming machine 1 are returned to the host station under step 90. The player may then either continue to play on gaming machine 1 or 2 or simply decide to receive currency in exchange for the remaining credits returned to the host station. To receive currency for the remaining credit, the player simply returns to the host station and request payment of credits under step 100 at the host or cash-in cashout station. In one embodiment of the present invention, the cash-in cashout station and the host station are combined into one station.

A worker skilled in the relevant art would be familiar with several ways to send credits from the gaming machines to the host station. For example, the credits could be returned to the host station through the use of hard meters or serial ports.

With further reference to FIG. 1, if the player decides to continue play on gaming machine 2 at step 110, the player simply activates gaming machine 2 through the use of the gaming token under step 120. Once the player activates gaming machine 2, the host station transfer the credits to gaming machine 2 under step 130. Once the credits are received, the player may then play gaming machine 2 until all credits are dispensed or until player decides to stop playing gaming machine 2 under steps 140 and 150. If the player decides to stop playing gaming machine 2 and still has credits remaining, the player simply depresses a cashout feature on the gaming machine 2 under step 160. Once the depress cashout feature is activated on gaming machine 2, the credits remaining on gaming machine 2 are returned to the host machine under step 170. The player may then either continue to play on gaming machine 1 or simply decide to receive currency in exchange for the remaining credits returned to the host station. To receive currency for the remaining credit, the player simply returns to the host station and requests payment of credits under step 100 at the host or cash-in cashout station.

With further reference to FIG. 1, if the player decides to continue play on gaming machine 1, the player simply activates gaming machine 1 through the use of the gaming token and any remaining credits on the host station are then transferred to the gaming machine 1 for play. The player may then continue to play on gaming machine 1 or until all credits are used by the player. In short, the sequence of events of the embodiment of FIG. 1 should be taken as illustrative rather than restricting.

In one embodiment of the present invention, the player may also add credits to the gaming token issued to him by simply presenting additional currency to the attendant at the host station. Once currency is provided, the credits are simply increased accordingly to the gaming token as provided to the player.

In one embodiment of the present invention, the host station automatically tracks the status of credits for each player in the gaming system.

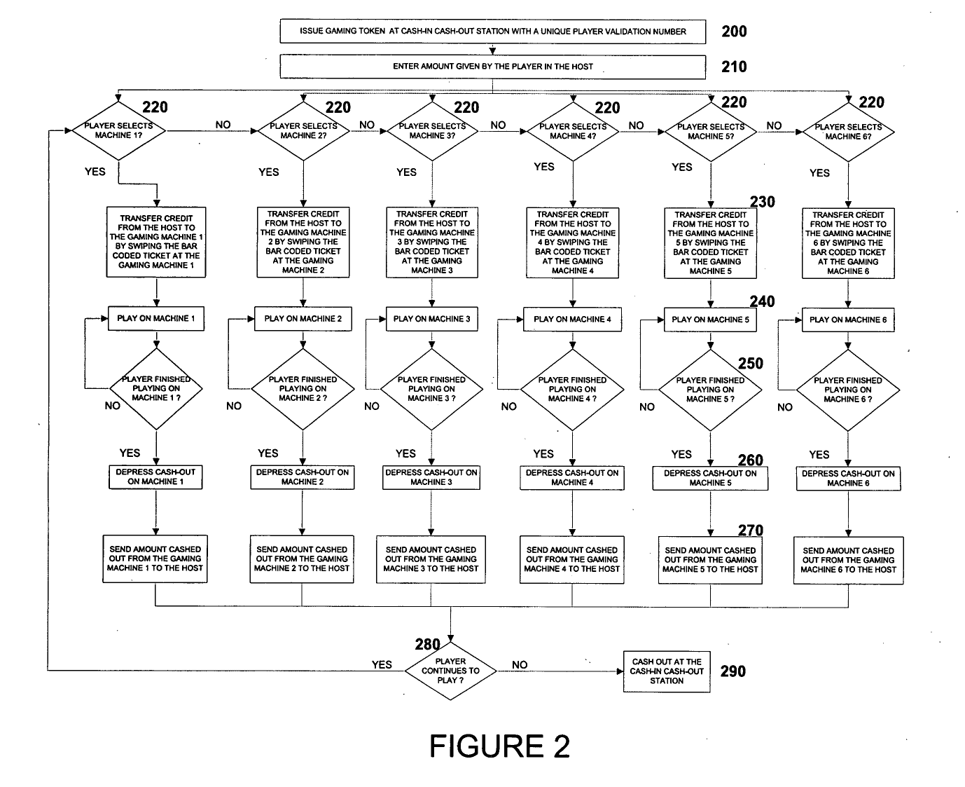

With reference to FIG. 2, one embodiment of the present invention comprises six gaming machines. The cashless method of the present invention commences with the issuance of a gaming token at step 200. Once the gaming token is issued, the amount of currency provided by the player is entered into the host station by an attendant at step 210. At step 220, the player decides among the six gaming machine he or she desires to play. Once a gaming machine is chosen, the player activates the gaming machine through the use of the gaming token. For example, if gaming machine 5 is chosen and activated by the player, the credits entered by the attendant in the host station are transferred to gaming machine 5 at step 230. At step 240, the player plays gaming machine 5 until all credits have been used or until player decides to stop play at step 250. At step 260, if player has any remaining credits on gaming machine 5, the cashout feature is activated and all remaining credits are transferred to the host station under step 270. At this time, the player may continue to play on another machine at step 280 or may request payment of remaining credit under step 290. If player decides to continue play, the player simply chooses another gaming machine at step 220 and activates the gaming machine of choice through the use of the gaming token. Once activated, the remaining credits are transferred to the gaming machine activated by the host station. Accordingly, the player may tempt his or her luck on all six gaming machines without having to enter any currency other than the initial time to obtain a gaming token.

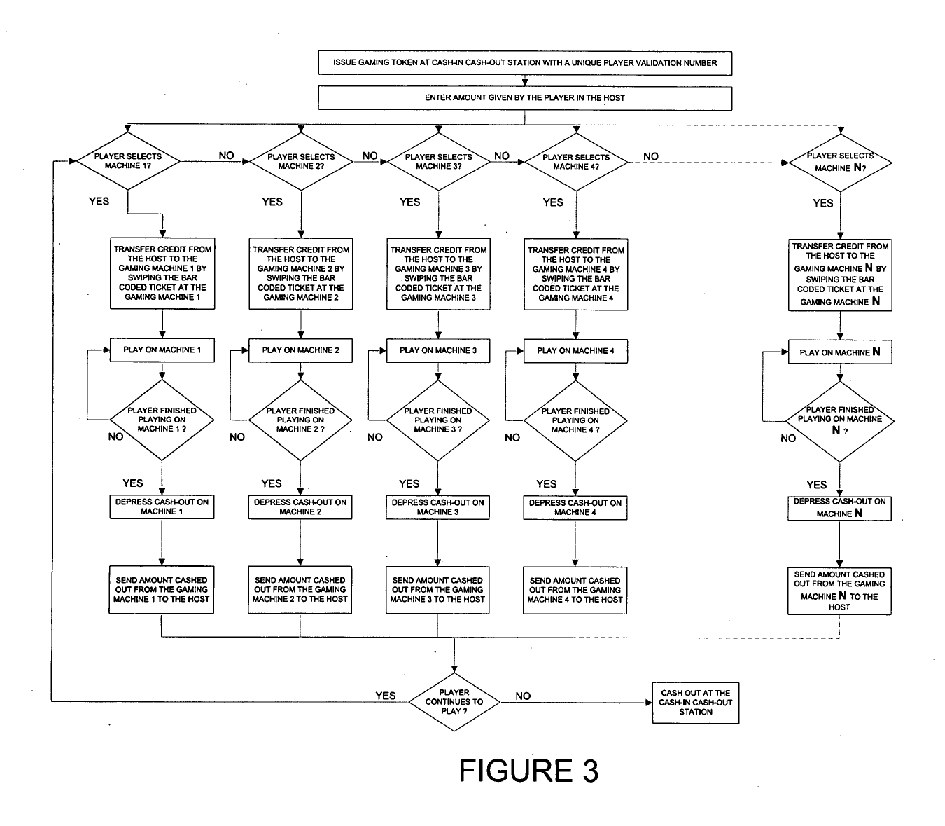

With reference to FIG. 3, a cashless method according to one embodiment of the present invention is shown with N gaming machines. The steps as described in FIG. 2 are simply repeated but with N gaming machine possibilities. Under this embodiment of the present invention, N is defined as a maximum of 768 gaming machines.

In another embodiment of the present invention, the host station monitors all player movements from one gaming machine to another. The attendant of the host station is also able to track all actions and transactions from all the connected gaming machines, including each “input” and “output” of each gaming machines.

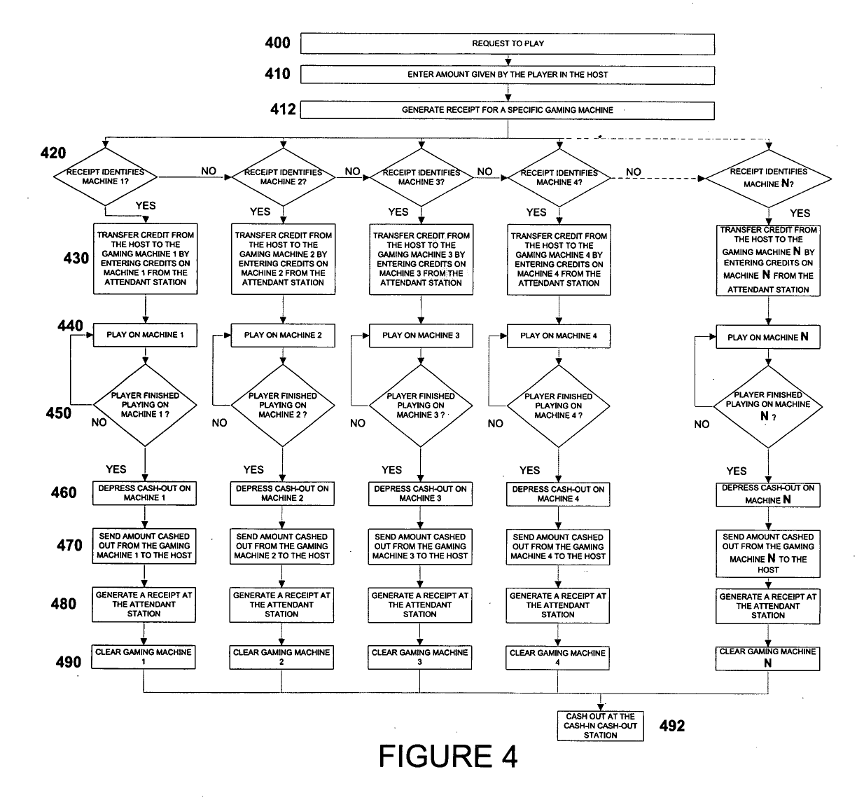

With reference to FIG. 4, a cashless method according to one embodiment of the present invention is shown with N gaming machines. Under this embodiment, N is defined to a maximum of 768 gaming machines. The cashless method of the present invention commences with a player requesting to play on one of the N gaming machines at step 400. The player provides currency to be used during play on a gaming machine. Once the currency is received by an attendant at the host station, the amount of currency provided by the player is entered into the host station at step 410. At step 412, a receipt is issued for a specific gaming machine within the N gaming machines under the embodiment of the present invention. Once the gaming machine is identified at step 420, the credits entered at the host are transferred by the host to the identified gaming machine at step 430. At step 440, the player plays gaming machine 1 as identified by the receipt, for example, until all credits have been used or until player decides to stop play at step 450. At step 460, if player has any remaining credits on gaming machine 1, the cashout feature is activated and all remaining credits are transferred to the host station under step 470. At step 480, a receipt is generated at the attendant station, gaming machine is cleared at step 490 and then the player receives payment at step 492.

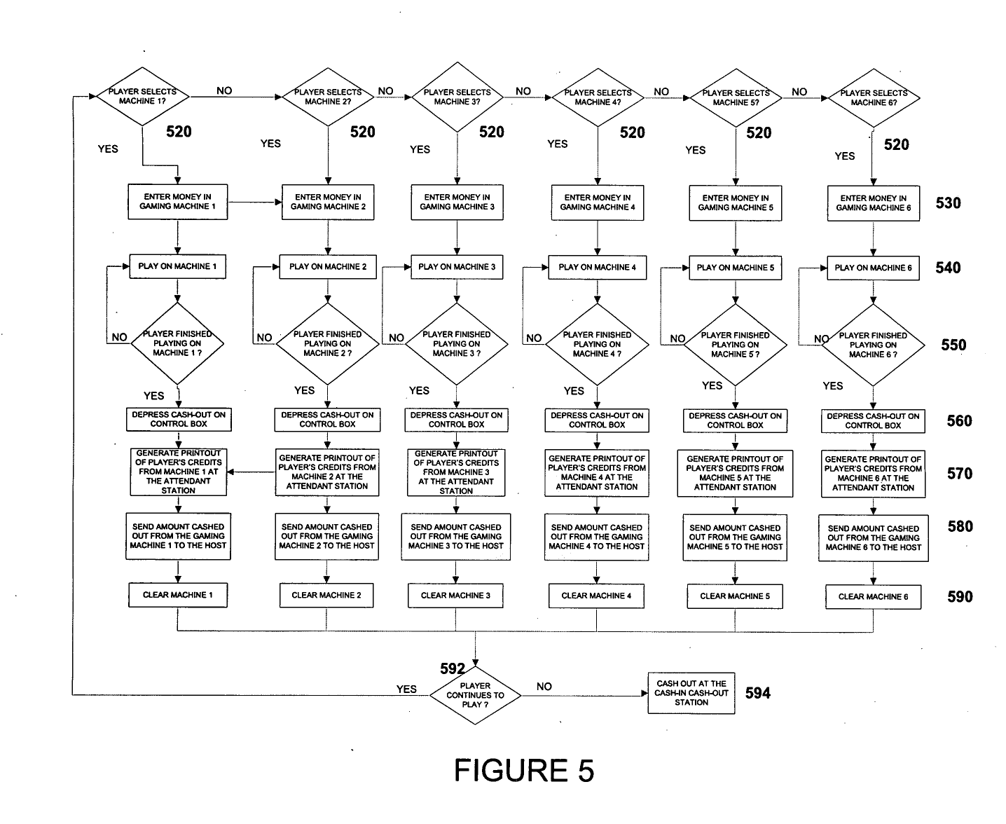

With reference to FIG. 5, a method requiring the use of currency according to one embodiment of the present invention is shown with six gaming machines. All gaming machines are interlinked to one another and can be controlled by a remote attendant. To commence playing on a particular machine, the player selects a gaming machine to activate at step 520. A gaming machine may be activated through the use of currency by simply entering the currency in the money slot of the selected gaming machine under step 530. Once the currency is entered into gaming machine, the player may play gaming machine 6 for example, until the value of the currency entered is used or until the player decides to stop playing gaming machine 6 under steps 540 and 550. If the player decides to stop playing gamine machine 6 and still has credits remaining in gaming machine 1, the remote attendant simply depresses a button on the control box under step 560. The control box is the link to all six gaming machines according to one embodiment of the present invention. Once the button on the control box is depressed, a printout of the player's credits is generated at the attendant station under step 570. All remaining credits are transferred to the host station under step 580 and credits on machine 6 are cleared under step 590. At this time, the player may continue to play on another machine at step 592 or may request payment of remaining credit under step 594. If player decides to continue play, the player simply chooses another gaming machine at step 520 and activates the gaming machine of choice by entering currency in the money slot and repeats the process under step 530. Accordingly, the player may tempt his or her luck on all six gaming machines.

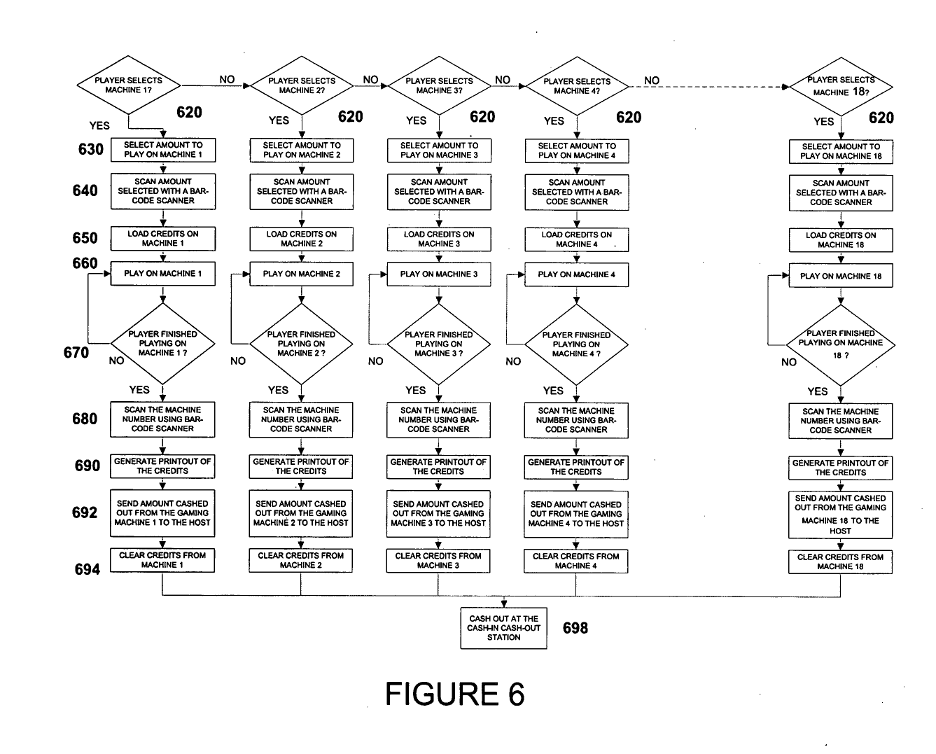

With reference to FIG. 6, a method requiring the use of currency according to one embodiment of the present invention is shown with eighteen gaming machines. To commence playing on a particular machine, the player selects a gaming machine to activate at step 620, selects an amount to be played at step 630 and provides the currency to the attendant. Using a bar-coded scanner, the attendant scans at step 640 the number of the gaming machine chosen along with the amount to be played. The credits are automatically loaded into the selected machine under step 650. Once the credits are loaded on the gaming machine, the player may play gaming machine 1 for example, until all the credits are used or until the player decides to stop playing gaming machine 1 under steps 660 and 670. If the player decides to stop playing gamine machine 1 and still has credits remaining in gaming machine 1, the attendant simply scans the gaming machine number using a bar-code scanner at step 680. Once the gaming machine number is scanned, a printout of the player's credits is generated at the attendant station under step 690. All remaining credits are transferred to the host station under step 692 and credits on the gaming machine are cleared under step 694. At this time, the player may continue to play on another machine at step 620 or may request payment of remaining credit under step 698.

If player decides to continue play, the player simply chooses another gaming machine at step 620 and activates the gaming machine of choice by entering currency in the money slot and repeats the process under step 630. Accordingly, the player may tempt his or her luck on all eighteen gaming machines.

It should be appreciated that a method for use in a cashless gaming peripheral device has been disclosed. It is to be expressly understood that the claimed invention is not to be limited to the description of the preferred embodiment or specific examples but encompasses all modifications and alterations within the scope and spirit of the inventive concept.

### Method

The method of the present invention is implemented in the preferred design set forth above and illustrated in the drawings. It is to be understood that this design is one of many possible designs incorporating the steps of:

(a) issuing a gaming token with a unique player validation number;

(b) entering an amount of currency as given by the player into the host station;

(c) activating a gaming machine to play through the use of the gaming token;

(d) transferring credit from the host station to a chosen gaming machine;

(e) playing on the chosen gaming machine;

(f) depressing cash-out option on the gaming machine when player finished playing on the gaming machine;

(g) sending the amount cashed out from the chosen gaming machine to the host station;

(h) cashing out at the host station when player no longer wishes to continue play on any other gaming machine.

In another embodiment of the present invention, a method for use in a gaming system comprises the steps of:

a) the player selects a gaming machine to play;

b) gaming machine selected is activated by either entering currency into the gaming machine or by the remote attendant;

c) once gaming machine is activated, player plays on gaming machine until all credits are used or until the player desires to stop playing with credits remaining;

d) if credits remain on gaming machine, player advises remote attendant of gaming machine played;

e) upon being advised by player, remote attendant activates control to printout total of remaining credits;

f) upon noting the remaining credits on gaming machine by the host station for cashout by the player, the gaming machine credits are cleared;

g) player presents himself to host station for payment of credits.

In another embodiment of the present invention, a method for use in a gaming system comprises the steps of:

a) player selects a gaming machine to be activated;

b) player provides currency to attendant at the host station for activation of selected gaming machine;

c) identification of machine and desired currency to be inputted into selected gaming machine is done through the use of a bar code;

d) upon reading of bar code, credits are automatically loaded onto selected gaming machine for activation and play;

e) player presents himself to gaming machine selected and plays until all credits are dispensed of or until player wishes to cashout remaining credits;

f) if player stops play on selected gaming machine with remaining credits, player returns to remote attendant station for cashout;

g) cashout of remaining credits is achieved by scanning the bar code of the gaming machine selected and a printout of the remaining credits is provided;

h) once the remaining credits are printed out by host station attendant, the gaming machine is cleared of all credits and available for use by a player.

In another embodiment of the present invention, a method for use in a gaming system comprises the steps of:

a) player requests to play a gaming machine;

b) player provides currency to attendant at the host for activation of a gaming machine;

c) identification of machine and desired currency to be inputted into selected gaming machine is entered into host station;

d) a receipt is issued from host station identifying gaming machine activated;

e) credits are automatically loaded onto activated gaming machine for activation and play;

f) player presents himself to gaming machine activated with receipt and plays until all credits are dispensed of or until player wishes to cashout remaining credits;

g) if player stops play on activated gaming machine with remaining credits, player returns to host station for cashout;

h) player can cashout on the activated gaming machine by depressing a cashout button on the activated gaming machine;

i) the amount cashed out is sent from the activated gaming machine to the host;

j) once the remaining credits are printed out by remote station attendant, the activated gaming machine is cleared of all credits and available for use by a player.

A worker skilled in the relevant art would understand the required technology to implement the methods described in the present invention.

It is to be understood that the above detailed descriptions of embodiments of the present invention is provided as examples only. Various details of the methods may be modified without departing from the scope of the invention.

1. A cashless method for operating a network of gaming machines comprising the steps of:
Issuing a gaming token to a player;
Entering amount of currency as given by player into a host station;
Activating a game machine from at least one or more gaming machines through the use of the gaming token;
Transferring credits to activated gaming machine;
Playing gaming machine activated;
Depressing a cash-out option on the gaming machine when player has finished playing on the gaming machine; and
Sending remaining credits from gaming machine to host machine
Wherein the player may continue to play at another gaming machine or simply be given currency equivalent to the remaining credits transferred to the host machine.

2. The cashless method of claim 1 wherein the step of transfer includes the step of swiping the bar coded ticket at the gaming machine.

3. The cashless method of claim 1 wherein gaming token is replaced by a RFID badge.

4. The cashless method of claim 1 wherein the gaming token is replaced by an electronically stored validation number that can be downloaded to the gaming machine via a wireless method or through electrical connections.

5. The cashless method of claim 1 wherein gaming token is replaced by a manually given validation number that can be entered on the gaming machine.

6. The cashless method of claim 1 wherein gaming token is replaced by an electronic fingerprint through sensors.

7. The cashless method of claim 1 wherein the gaming token is replaced by a bar coded ticket.

8. The cashless method of claim 1 wherein gaming token is replaced by a smart card.

9. The cashless method of claim 1 wherein gaming token is replaced by a magnetic stripe card.

10. The cashless method of claim 1 wherein gaming token is replaced by a magnetic stripe card with a re-writeable thermal side to print the remaining credit left to the player.

11. The cashless method of claim 1 wherein entering amount as given by the player into a host machine can be done via a self-service kiosk.

12. The cashless method of claim 1 wherein sending credits from gaming machine to host machine can be done via hard meters.

13. The cashless method of claim 1 wherein sending credits from gaming machine to host machine can be done via a serial port.

14. A cashless method for operating a network of gaming machines comprising the steps of:
Player selects a gaming machine to be activated;
Player provides currency to remote attendant for activation of selected gaming machine;
Identification of machine and desired currency to be inputted into selected gaming machine is done through the use of a bar code;
Upon reading of bar code, credits are automatically loaded onto selected gaming machine for activation and play;
Player presents himself to gaming machine selected and plays until all credits are dispensed of or until player wishes to cashout remaining credits;
Cashout of remaining credits is achieved by scanning the bar code of the gaming machine selected and a printout of the remaining credits is provided; and
Once the remaining credits are printed out by remote station attendant, the gaming machine is cleared of all credits and available for use by another player.

15. A method for use in a gaming system comprises the steps of:
Player selects a gaming machine to play;
Gaming machine selected is activated by either entering currency into the gaming machine or by the remote attendant;
Once gaming machine is activated, player plays on gaming machine until all credits are used or until the player desires to stop playing with credits remaining;
If credits remain on gaming machine, player advises remote attendant of gaming machine played;
Upon being advised by player, remote attendant activates control to printout total of remaining credits;
Upon noting the remaining credits on gaming machine by the remote attendant for cashout by the player, the gaming machine credits are cleared; and
Player presents himself to remote attendant station for payment of credits.

16. A method for use in a gaming system comprises the steps of:
Player selects a gaming machine to be activated;
Player provides currency to remote attendant for activation of selected gaming machine;
Identification of machine and desired currency to be inputted into selected gaming machine is entered into host station;
A receipt is issued from host station identifying gaming machine chosen by player;
Credits are automatically loaded onto selected gaming machine for activation and play;
Player presents himself to gaming machine selected with receipt and plays until all credits are dispensed of or until player wishes to cashout remaining credits;
If player stops play on selected gaming machine with remaining credits, player returns to host station for cashout;
Cashout of remaining credits is achieved by scanning the bar code of the gaming machine selected and a printout of the remaining credits is provided;
Once the remaining credits are printed out by remote station attendant, the gaming machine is cleared of all credits and available for use by a player.
